(19) United States
(12) Patent Application Publication
(10) Pub. No.: US 2021/0078778 A1
(43) Pub. Date: Mar. 18, 2021

(54) WINE BARREL TOPPING INTERFACE

(71) Applicant: THOMAS JOHN SHUDIC, BURBANK, CA (US)

(72) Inventor: THOMAS JOHN SHUDIC, BURBANK, CA (US)

(21) Appl. No.: 16/876,016

(22) Filed: May 16, 2020

Related U.S. Application Data
(60) Provisional application No. 62/849,881, filed on May 18, 2019.

(51) Int. Cl. B65D 51/16; C12H 1/22

(52) U.S. Cl. CPC B65D 51/1644; C12H 1/22

(57) ABSTRACT

My invention, in conjunction with COTS (commercial off the shelf) items, permits automatic topping of one or more wine barrels, thereby excluding air space in the barrel. A system that utilizes my invention assures that barrels connected to it will remain completely full for as long as is desired, with nearly zero maintenance and extremely low risk of contamination.

### SUMMARY OF THE INVENTION

The invention presented describes a hardware interface that is inserted into the bunghole of a standard wine barrel. It consists of a food-grade silicone rubber bung carrying three stainless steel tubes and a retaining device to ensure that it stays firmly affixed in the barrel. The device is designed in such a way that it can be installed into and removed from a barrel from the outside through the bunghole, so there is no need to take apart the barrel to deploy or remove the device.

Nota bene: All parts except for the Silicone Bung (G) are fabricated from alloy316 stainless steel. Silicone Bung (G) is food-grade silicone rubber.

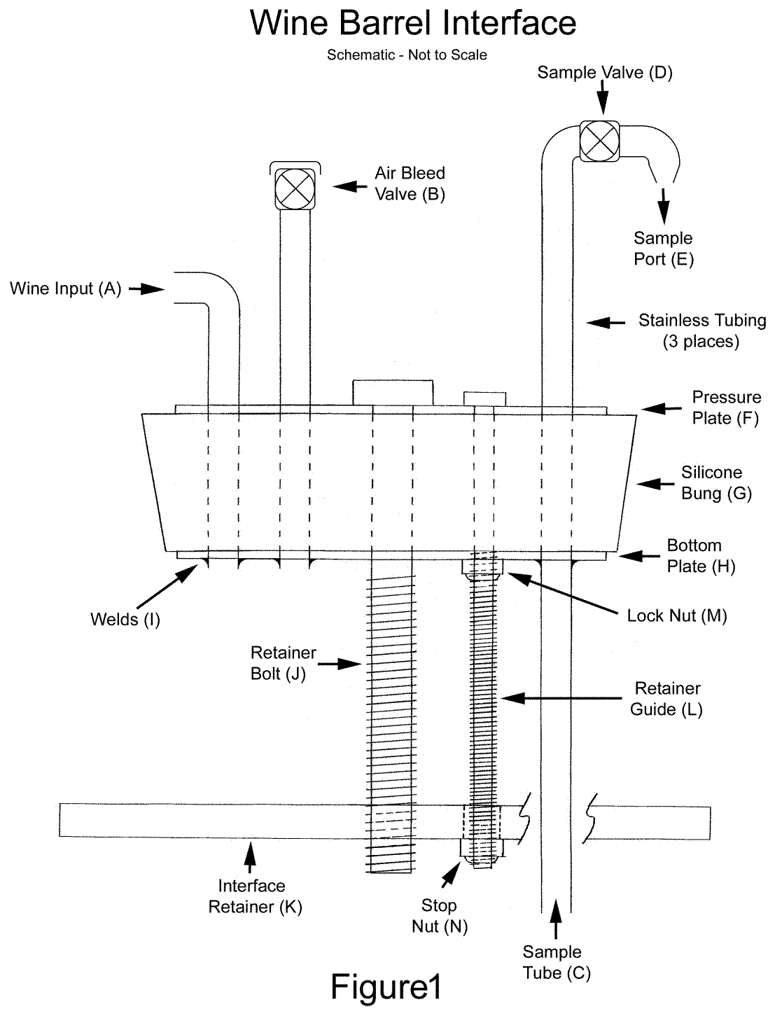

### LISTING OF THE HARDWARE INTERFACE COMPONENTS AND PICTURES AS SHOWN IN FIG. 1, PHOTO1 AND PHOTO2

(A) Wine Input
(B) Air Bleed Valve
(C) Sample Tube
(D) Sample Valve
(E) Sample Port
(F) Pressure Plate
(G) Silicone Bung
(H) Bottom Plate
(I) Welds (3 places)
(J) Retainer Bolt
(K) Interface Retainer
(L) Retainer Guide
(M) Lock Nut
(N) Stop Nut

FIG. 1—Schematic representation of all components of the Wine Barrel Interface.

Photo1—View of the Wine Barrel Interface installed in an actual barrel bung stave.

Photo2—Sequence showing the Wine Barrel Interface installation.

### FUNCTIONAL DESCRIPTION OF EACH COMPONENT SHOWN IN FIG. 1

Wine Input (A)—Topping wine from a pressurized container enters the barrel through this fitting.

Air Bleed Valve (B)—Permits expulsion of air trapped in the barrel after the installation of the Wine Barrel Interface.

Sample Valve Tube (C)—This tube extends from the middle of the barrel through the Wine Barrel Interface. It facilitates a representative sampling of the contents of the barrel while the barrel is under pressure.

Sample Valve (D)—Regulates the flow of wine from the barrel during sampling of the contents of the barrel.

Sample Port (E)—The wine sample emerges from this port.

Pressure Plate (F)—This plate applies pressure to the top of the Wine Barrel Interface during installation, and it maintains pressure after installation to keep the Wine Barrel Interface from leaking or popping loose from the barrel. All three tubes, the Retainer Bolt (J) and the Retainer Guide (L) are at pass-through clearance through Pressure Plate (F).

Silicone Bung (G)—This seals the Wine Barrel Interface tightly in the bunghole of the barrel during installation.

Bottom Plate (H)—The three stainless steel tubes are welded to this plate. The Retainer Bolt (J) passes through the center of this plate, and the Retainer Guide (L) is threaded through this plate.

Welds (I)—Shows the location of the three welds which hold all components in place, both during installation and operation.

Retainer Bolt (J)—Pulls the Interface Retainer (K) tightly against the inside of the wine barrel's bung stave while pushing against Pressure Plate (F), thereby squeezing the Silicone Bung (G) against the inside of the barrel's tapered bunghole, thereby preventing leakage of fluids from the barrel.

Interface Retainer (K)—This is a rigid, rectangular piece of steel with a threaded hole in its center which the Retainer Bolt (J) screws into. There is also a clearance hole (non-threaded) which the Retainer Guide (L) passes through. The Interface Retainer (K) is sufficiently long (approximately 2% inches) to over-span the bottom of the bunghole by about one quarter inch on each end (See Photo1). This permits the Wine Barrel Interface assembly to be firmly secured by the tension along the Retainer Bolt (J) between the Pressure Plate (F) and the inside of the wine barrel stave, via Interface Retainer (K).

Retainer Guide (L)—This passes through Interface Retainer (K) to prevent its rotation during installation or removal of the Wine Barrel Interface (See Photo1). Lock Nut (M)—Retainer Guide (L) is threaded through Bottom Plate (H). Lock Nut (M) firmly secures Retainer Guide (L) to Bottom Plate (H).

Stop Nut (N)—During removal of the Wine Barrel Interface, Stop Nut (N) prevents dropping Interface Retainer (K) into the barrel in case Retainer Bolt (J) becomes completely disengaged from Interface Retainer (K).

### Working Description of the Wine Barrel Interface Installation

The Wine Barrel Interface is designed to be installed into (or removed from) a full barrel of wine, with no need of removal of the contents (See Photo2). Once the Interface is inserted, the winemaker checks to see that the Interface Retainer (K) is aligned parallel with the bung stave. He then pushes the Wine Barrel Interface firmly into the bunghole and tightens Retainer Bolt (J) until it is snug. Making sure that the Air Bleed Valve (B) and the Sample Valve (D) are closed, the source of wine from a container under low (˜2 psi) pressure is connected to Wine Input (A) and turned on. After a check for leaks at the Silicone Bung (G), the Air Bleed Valve (B) is cracked open until wine appears at the output. Air Bleed Valve (B) is then closed and the barrel is again checked for leaks at the Silicone Bung (G). If necessary, the Retainer Bolt (J) is tightened until the leak stops. Then, while holding a cup under the spout, the winemaker opens Sample Valve (D) until only a solid stream of wine is emitted. He then wipes up any spilled wine and moves on to the next barrel.

As long as there is a steady, uninterrupted source of wine at Wine Input (A) the barrel will remain full to the top for years if long-term aging is desired. The progress of aging can be checked periodically by tasting and chemical analysis of wine from Sample Port (E).

1. Introduction—the Current Method
Although barrels used for the purpose of aging wine are generally free of leakage issues that may result in spoilage, the wooden staves of barrels are semi-permeable to a small degree. During aging, evaporation of both water and alcohol through the barrel staves occurs very slowly, resulting in a beneficial concentration of the flavor elements of the wine remaining in the barrel. During this process, a headspace forms above the wine, exposing the wine to an oxygen-depleted partial vacuum. If the barrel is not maintained regularly, this headspace would eventually enlarge sufficiently to enable the growth of spoilage organisms and oxidation of the wine. To avoid this calamity, barreled wine is generally “topped-up” on a regular schedule, varying from three to six weeks. Topping-up entails opening the barrel, inspecting the contents for signs of spoilage by visual and olfactory examination, occasionally sampling the wine by withdrawing a portion for either tasting or chemical analysis, refilling the head space with wine reserved in neutral, non-porous containers, and resealing the barrel.
This task is done manually by a cellar worker, and is a rather time-consuming task in a large winery. Another method for reducing or eliminating oxygen, such as sparging with inert gas (nitrogen or argon), is common practice in the industry, but only works well with non-porous containers and for short-term storage.
Introduction (Contd.)—Prior Efforts and Materials Considerations
Inflatable bladders have also been tried with mixed results, but they have not received wide acceptance.

6. The concept of keeping wine continuously protected from spoilage while in barrel has been around for decades, but has not been adequately addressed from a materials standpoint. In November 1999, Mastrocola (U.S. Pat. No. 5,976,583) patented a similar device, constructed of food-grade silicone rubber. He had the right general concept, but the wrong approach for wine. Research into the oxygen permeability of not only silicones, but all plastics in general, rendered it obvious that none of them are suitable for anything but very short-term usage as containment or transport vessels for wine. Rubber or plastic tubing is commonly used for soft drink and beer dispensing equipment in the food service industry, but the retention time within those systems is very short—a matter of hours or days—so oxidation of the product is not a significant quality issue. However, because the exposure time for aging red wines could be as much as two or three years, plastics are completely unacceptable for this application.

7. This invention employs a stainless-steel keg for the topping wine (see photo), which is maintained at a slight positive pressure by inert gas (argon or nitrogen). The interface at the barrel is crucial, as it is the heart of the system. It and all the rest of the system employs stainless-steel tubing and fittings throughout, which is totally inert with respect to wine. It is also durable, indefinitely reusable and easy to sanitize.

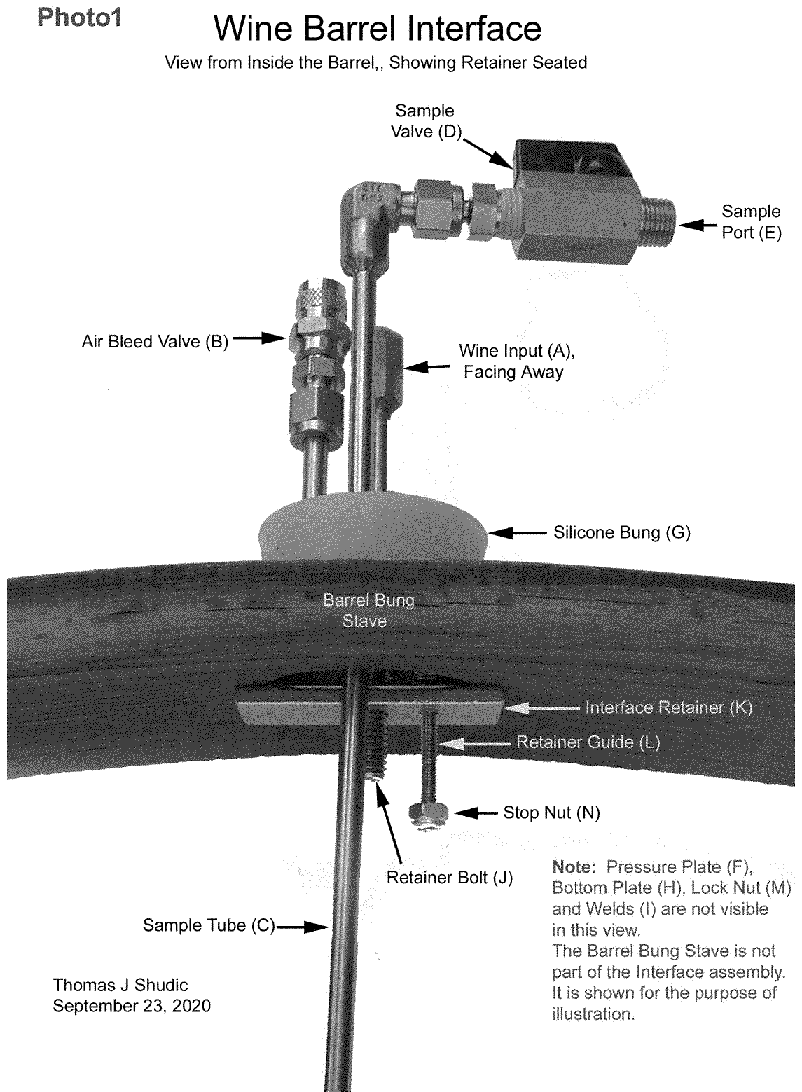

8. Although silicone rubber has been the industry standard material from which barrel bungs are made since circa 1980, the aspect ratio of the surface area exposed in this invention, as well as the considerable thickness of the bungs renders the oxygen permeability through them insignificant. That small exposure is further reduced by the stainless-steel Bottom Plate (L) at the bottom of the Silicone Bung (E), (FIG. 2), to which the tubing into and out of the interface is welded.

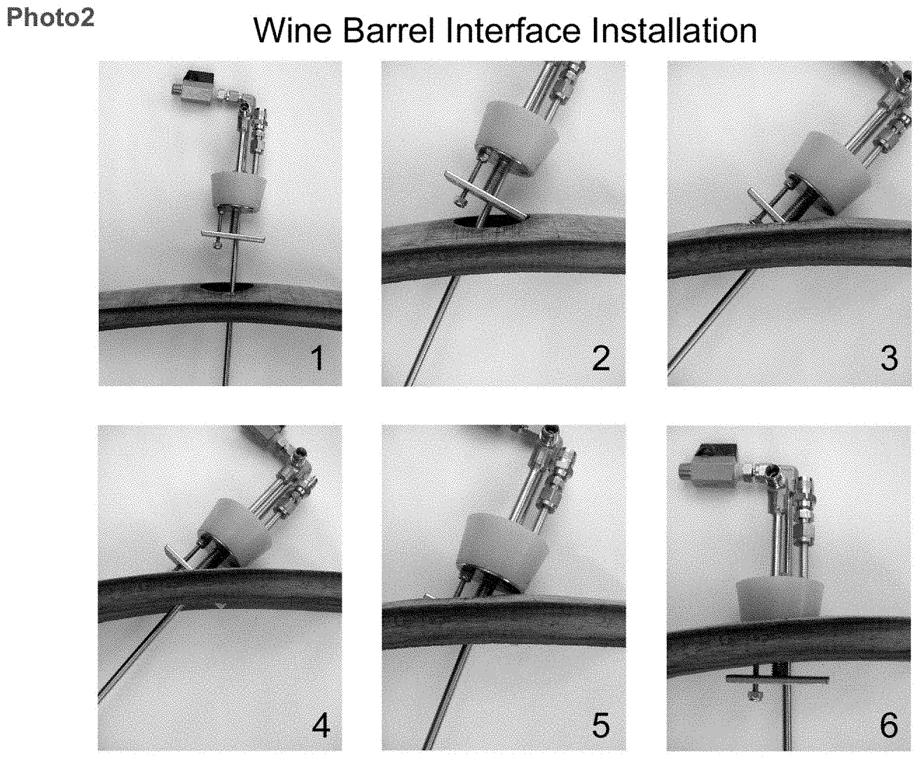

9. The interface is designed to be easily installed in or removed from a full barrel of wine (see FIG. 3). Once the interface is in place and fastened securely, the Wine Input (A) (FIG. 2) is connected to a low-pressure source of wine, the Sample Valve (C) is closed, the Air Bleed Valve (C) is cracked open, and the source is turned on. As soon as wine begins to appear at Air Bleed Valve (C), it is tightly closed. The air is then bled from Sample Valve (C), whereupon that valve is also closed.

10. As long as the wine source remains constant and at low positive pressure, the flow of topping wine into the barrel will be controlled by the barrel's evaporation through its staves. The barrel will remain completely full and protected from spoilage. The entire setup can remain in place for years with no need of any maintenance whatsoever, as long as the source of wine remains constant and the barrel suffers no damage. The winemaker is free to attend to other duties in the meanwhile, as well as sampling the wine as it gracefully matures unattended and safe from oxidation and/or microbial spoilage.

11. This invention can work in any winery operation, large or small, but the labor cost benefits are scalable and tend to favor very large operations. However, the quality improvement benefits accrue equally to any size operation.

12. Although a similar invention (Mastrocola, U.S. Pat. No. 5,976,583) had the right general concept for continuous topping of wine barrels, his choice of silicone rubber tubing and containers was not appropriate for anything but shortterm storage of wine because of the high oxygen permeability of such products; other types of plastics are similarly inappropriate, and only stainless steel, which my Wine Barrel Topping Interface employs, has zero permeability, rendering it the best choice of materials for this approach.

13. As long as there is a steady, uninterrupted source of wine at Input (A) [See FIG. 1] of the Wine Barrel Topping Interface, the barrel will remain full to the top for years if long-term aging is desired, and the progress of aging can be checked periodically by tasting and chemical analysis of wine from Sample Port (E) [See FIG. 1].

14. The Wine Barrel Topping Interface is: designed to be easily installed in or removed from a full barrel of wine, thereby avoiding the need to disassemble the wine barrel for installation (See Photo2); durable, easily cleaned, and reusable; and a very attractive labor-saving/cost-reducing/quality-improving tool, both for large scale wineries and high-end boutique wineries.

15. Although a similar invention (Mastrocola, U.S. Pat. No. 5,976,583) had the right general concept for continuous topping of wine barrels, his choice of silicone rubber tubing and containers was not appropriate for anything but shortterm storage of wine because of the high oxygen permeability of such products; other types of plastics are similarly inappropriate, and only stainless steel, which my Wine Barrel Topping Interface employs, has zero permeability, rendering it the best choice of materials for this approach.

16. As long as there is a steady, uninterrupted source of wine at Input (A) [See FIG. 1] of the Wine Barrel Topping Interface, the barrel will remain full to the top for years if long-term aging is desired, and the progress of aging can be checked periodically by tasting and chemical analysis of wine from Sample Port (E) [See FIG. 1].

17. The Wine Barrel Topping Interface is: designed to be easily installed in or removed from a full barrel of wine, thereby avoiding the need to disassemble the wine barrel for installation (See Photo2); durable, easily cleaned, and reusable; and a very attractive labor-saving/cost-reducing/quality-improving tool, both for large scale wineries and high-end boutique wineries.
